(19) United States
(12) Patent Application Publication
(10) Pub. No.: US 2006/0062188 A1
(43) Pub. Date: Mar. 23, 2006

(54) Replay prevention in wireless communications networks

(76) Inventors: Kaisa Nyberg, Helsinki (FI); Kaarle Ritvanen, Espoo (FI)

Correspondence Address: MORGAN & FINNEGAN, LLP, 3 World Financial Center, New York, NY, 10281-2101, US

(21) Appl. No.: 10/944,042

(22) Filed: Sep. 20, 2004

(51) Int. Cl. H04L 12/26; H04Q 7/24

(52) U.S. Cl. 370/338; 370/252; 370/229

(57) ABSTRACT

A secure frame is received from a remote device across a wireless communications network, such as an IEEE 802.15.3 or IEEE 802.15.3a network. Upon obtaining a secure frame counter (SFC) value from the secure frame, the frame is accepted or rejected based upon the occurrence of one or more acceptance conditions. The one or more acceptance conditions may include an SFC value of the received frame being greater than any previously received SFC value, or the SFC value of the received frame being within the tracking window and being previously unused.

### FIELD OF THE INVENTION

The present invention relates to wireless communications. More particularly, the present invention relates to techniques for preventing the replay of transmissions in wireless communications networks.

### BACKGROUND OF THE INVENTION

Short-range wireless proximity networks typically involve devices that have a communications range of one hundred meters or less. To provide communications over long distances, these proximity networks often interface with other networks. For example, short-range networks may interface with cellular networks, wireline telecommunications networks, and the Internet.

IEEE 802.15.3 defines an ad hoc wireless short-range network (referred to as a piconet) in which a plurality of devices may communicate with each other. One of these devices is called piconet coordinator (PNC), which coordinates timing and other operational characteristics for the network. The remaining devices in the network are known as DEVs. The timing of piconets is based on a repeating pattern of “superframes” in which the network devices may be allocated communications resources.

A high rate physical layer (PHY) standard is currently being selected for IEEE 802.15.3a. The existing IEEE 802.15.3 media access control layer (MAC) is supposed to be used as much as possible with the selected PHY. Currently, there are two remaining PHY candidates. One of these candidates is based on frequency hopping application of orthogonal frequency division multiplexing (OFDM). The other candidate is based on M-ary Binary offset Keying. The OFDM proposal is called Multiband OFDM (MBO). Moreover, in order to further develop the OFDM proposal outside of the IEEE, a new alliance has been formed called the MultiBand OFDM Alliance (MBOA).

MBO utilizes OFDM modulation and frequency hopping. MBO frequency hopping may involve the transmission of each of the OFDM symbols at various frequency according to according to pre-defined codes, such as Time Frequency Codes (TFCs). Time Frequency Codes can be used to spread interleaved information bits across a larger frequency band.

Presently, there is an interest within the MBOA to create a Medium Access Control (MAC) layer that would be used with the OFDM physical layer instead of the IEEE 802.15.3 MAC layer. Part of this development involves the development of secure features that work well for OFDM transmission environments, in which frames may be received out of order.

MAC layers govern the exchange among devices of transmissions called frames. A MAC frame may have various portions. Examples of such portions include frame headers and frame bodies. A frame body includes a payload containing data associated with higher protocol layers, such as user applications. Examples of such user applications include web browsers, e-mail applications, messaging applications, and the like.

Frame bodies may be in either a secure or a non-secure format. A secure formatted frame includes encrypted portions and further includes information to ensure its uniqueness. A secure implementation involves protecting against replay. Replay occurs when a frame is received that is not authentic. Accordingly, techniques are required for effective replay prevention in wireless networks.

### SUMMARY OF THE INVENTION

The present invention provides an apparatus having a receiver, a first register, a second register, and a controller. The receiver receives frames from a remote device across a wireless communications network (e.g., an IEEE 802.15.3 network). Each of the frames has a secure frame counter (SFC). The first register stores a highest received SFC value and the second register tracks previously used SFC values within a tracking window. The controller accepts or rejects a newly received frame. Such acceptance may be based on the occurrence of one or more acceptance conditions.

In a further aspect, the present invention provides an apparatus having a receiver, a processor, and a memory. The receiver receives frames from a remote device across a wireless communications network, where each of these frames has a secure frame counter (SFC). The

memory stores a first register that stores a highest value SFC of a received frame, and a second register that tracks previously used SFC values within a tracking window. The memory further stores instructions for the processor to accept a newly received frame upon the occurrence of one or more acceptance conditions.

A method of the present invention receives a secure frame from a remote device across a wireless communications network; obtains a secure frame counter (SFC) value from the secure frame; and accepts the received frame upon the occurrence of one or more acceptance conditions.

The present invention also provides a computer program product including a computer useable medium having computer program logic recorded thereon. The computer program logic includes program code for enabling the processor to receive a secure frame from a remote device across a wireless communications network; program code for enabling the processor to obtain a secure frame counter (SFC) value from the secure frame; and program code for enabling the processor to accept the received frame upon the occurrence of one or more acceptance conditions.

These aforementioned acceptance conditions may include an SFC value of the received frame being greater than any previously received SFC value, or the SFC value of the received frame being within the tracking window and being previously unused.

The present invention advantageously provides security in a manner that promotes efficient device operation and efficient use of communications resources. Further features and advantages of the present invention will become apparent from the following description and accompanying drawings.

### BRIEF DESCRIPTION OF THE DRAWINGS

In the drawings, like reference numbers generally indicate identical, functionally similar, and/or structurally similar elements. The drawing in which an element first appears is indicated by the leftmost digit(s) in the reference number. The present invention will be described with reference to the accompanying drawings, wherein:

FIG. 1 is a diagram of an exemplary operational environment;

FIG. 2 is a diagram showing an exemplary IEEE 802.15.3 superframe format;

FIG. 3 is a diagram of a secure frame according to an embodiment of the present invention;

FIG. 4 is a block diagram of an exemplary wireless communications device architecture according to an embodiment of the present invention;

FIG. 5 is a block diagram of an exemplary implementation of a wireless communications device according to an embodiment of the present invention;

FIG. 6 is a flowchart of a device operation, according to an embodiment of the present invention; and

FIGS. 7 and 8 are diagrams illustrating exemplary interactions between two devices according to embodiments of the present invention;

### DETAILED DESCRIPTION OF THE PREFERRED EMBODIMENTS

I. Operational Environment

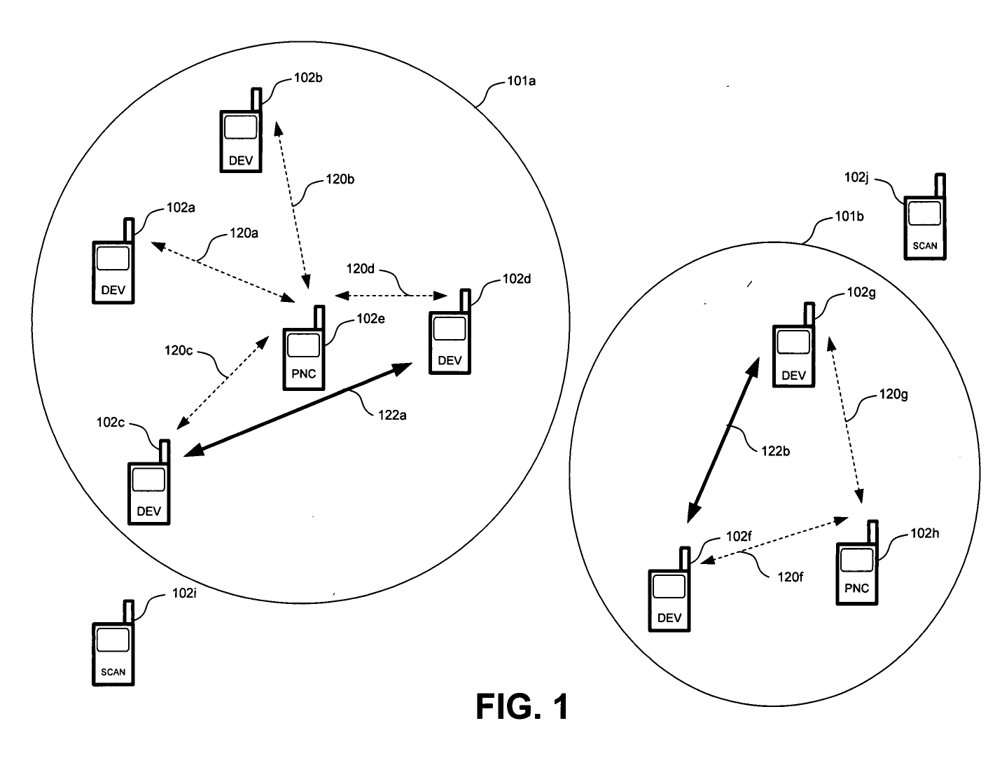

Before describing the invention in detail, it is first helpful to describe an environment in which the present invention may be employed. Accordingly, FIG. 1 is a diagram of an exemplary operational environment. This environment includes multiple piconets 101, each having a plurality of devices 102. For instance, FIG. 1 shows a piconet 101a, which includes a piconet coordinator (PNC) 102e, and member devices (DEVs) 102a-d. FIG. 1 also shows a piconet 101b, which includes a PNC 102h, as well as DEVs 102f and 102g.

In piconet 101a, each of devices 102a-d communicates with PNC 102e across a corresponding link 120. For example, DEV 102a communicates with PNC 102e across a link 120a. In addition, DEVs 102a-d may communicate with each other directly. For instance, FIG. 1 shows DEVs 102c and 102d communicating via a direct link 122a.

In piconet 101b, each of DEVs 102f and 102g may communicate with PNC 102h across a corresponding link 120. For instance, DEV 102f communicates with PNC 102h across a link 120f, while DEV 102g communicates with PNC 102h across a link 120g. Member devices in piconet 101b may also communicate with each other directly. For example, FIG. 1 shows DEVs 102f and 102g communicating across a link 122b.

Each of links 122 and 120 may employ various frequency hopping patterns. These patterns may include, for example, one or more Time Frequency Codes (TFCs). In embodiments of the present invention, each piconet 101 employs a particular frequency hopping pattern. These patterns may either be the same or different.

In addition, the environment of FIG. 1 shows a device 102i and a device 102j. These devices are not members of piconets 101a or 101b. Rather, these devices monitor or scan piconet transmissions. For instance, device 102i scans the transmissions of piconet 101a and device 102j scans the transmissions of piconet 101b. Accordingly, these devices are referred to herein as scanning devices.

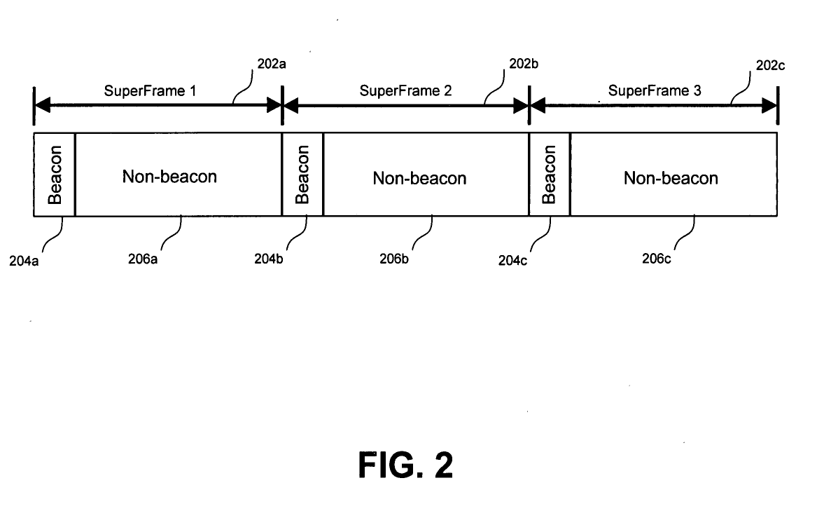

Transmissions of piconets 101a and 101b are each based on a repeating pattern called a superframe. Accordingly, FIG. 2 is a diagram showing an exemplary IEEE 802.15.3 superframe format. In particular, FIG. 2 shows a frame format having superframes 202a, 202b, and 202c. As shown in FIG. 2, superframe 202b immediately follows superframe 202a, and superframe 202c immediately follows superframe 202b.

Each superframe 202 includes a beacon portion 204 and a non-beacon portion 206. Beacon portions 204 convey transmissions from a PNC (such as PNC 102e) and are used to set timing allocations and to communicate management information for the piconet. For example, beacon portions 204 may convey transmissions that direct devices in piconet 101a (e.g., DEVs 102a-d) to employ certain frequency hopping patterns, such as specific TFCs. In addition, according to the present invention, beacon portions 206 may be used to transmit information regarding services and features of the transmitting PNC (e.g., information services, applications, games, topologies, rates, security features, etc.) or any device within the piconet. The transmission of such information in beacon portions 204 may be in response to requests from devices, such as scanning devices.

Non-beacon portions 206 are used for devices to communicate data according to, for example, frequency hopping techniques that employ OFDM and/or TFCs. For instance, non-beacon portions 206 may support data communications across links 120 and 122. In addition, devices (e.g., DEVs 102a-d) may use non-beacon portions 206 to transmit control information, such as request messages to other devices (e.g., PNC 102e). To facilitate the transmission of traffic, each DEV may be assigned a particular time slot within each non-beacon portion 206. These time slots may be allocated by the PNC.

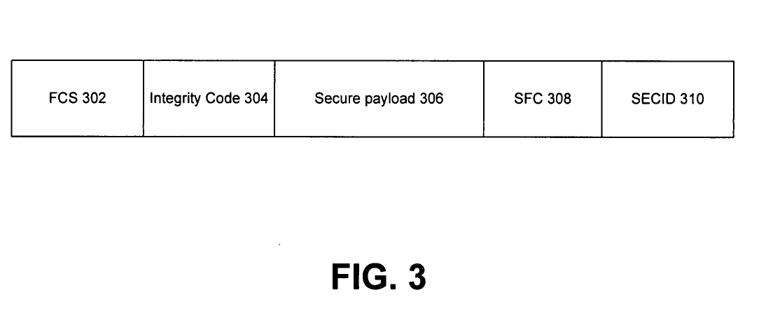

Traffic may be transmitted in the form of frames. As discussed above, the frames may be in a secure format. FIG. 3 is a diagram of an exemplary secure frame format according to one embodiment of the present invention. As shown in FIG. 3, this frame format includes various fields, such as a frame check sequence (FCS) 302, an integrity code 304, a secure payload 306, a secure frame counter (SFC) 308, and a secure session ID (SECID) 310.

II. SECURITY

To ensure communications security, it is a goal of wireless communications networks to prevent the replaying of frames. Also it is desirable that the order of frames is preserved. As an attempt to achieve these objectives, various wireless systems implement counters and time varying parameters. These counters and parameters may be employed by receiving devices to verify the order and freshness of received frames.

For example, in IEEE 802.15.3 networks, superframe-based counters are employed. Section 9.1.7 of the current IEEE 802.15.3 standard provides for the following:
“. . . A DEV in a secure piconet maintains two values for freshness. The CurrentTimeToken is the time token value found in the beacon for the current superframe and is used to protect all messages sent and check all messages received during that superframe. The LastValidTimeToken is used by the DEV to ensure that the security of the beacons has not been compromised.” IEEE Standard for Information Technology; Telecommunications and information exchange between systems; Local and metropolitan area networks; Specific requirements; Part 15.3: Wireless Medium Access Control (MAC) and Physical Layer (PHY) Specifications for High Rate Wireless Personal Area Networks (WPANs). IEEE Standard 802.15.3-2003, September 2003, hereinafter IEEE Standard 802.15.3-2003.

IEEE 802.15.3 networks protect secure frames using encryption and a message integrity code. Each encryption is initialized using a counter value, called a Secure Frame Counter (SFC), which is incremented for each new frame. However, these mechanisms are not sufficient to prevent replaying of frames during the same superframe under which they were originally sent. For instance, current specifications do not require that SFC values of used frames also be checked to ensure that an SFC value has not been used more than once. However, the fragmentation control field also includes an SDU sequence number that is used to detect duplicate transmissions of SDUs or fragments thereof. Inclusion of such data to the nonce might seem to exclude any possibility for frame replay. However, the length of that sequence number is only 9 bits, and it might well roll over during a superframe. Therefore it is essential to check that no SFC value is used more than once.

Currently, the MBOA is considering approaches regarding the secure numbering of frames. For instance, use of the CCM algorithm has been proposed to be used for securing frames and their numbering. The CCM algorithm is described in document RFC 3610 entitled “Counter with CBC-MAC (CCM)”. This document is incorporated herein by reference in its entirety and may be downloaded from the Internet at ftp://ftp.rfc-editor.org/in-notes/rfc3610.txt.

CCM is an authenticated encryption mode of operation for block ciphers. In addition to concealing data from eavesdroppers, CCM ensures that the ciphertext was generated by someone who knows the secret key and that it has not been modified by anyone else. If such action takes place, CCM ensures that it will be detected with an overwhelming probability.

CCM is used in conjunction with a 128-bit block cipher. This cipher is typically the Advanced Encryption Standard (AES). CCM mode requires four input values: an encryption key, a unique value called the nonce, a plaintext message to be encrypted and authenticated, and additional authenticated data (AAD) that is not encrypted but authenticated.

The format of the encryption key depends on the block cipher. The nonce is a unique value in that it has not been used with the same encryption key before. The AAD typically consists of link layer header fields, which cannot be encrypted but must be protected against tampering.

The counter value (the secure frame counter) is usually transmitted along with the message, since decryption of the message requires knowing it. The nonce is required to be unique with respect to the encryption key. If the same nonce is used more than once, a potential eavesdropper gains partial knowledge of the plaintexts.

To ensure the uniqueness of the nonce, a monotonically increasing counter value is usually used when constructing the nonce value. As it is transmitted along the message, the receiver can observe whether the counter value really has been incremented for each message.

IEEE 802.15.3 applies a security framework involving secure frame counters (SFCs) that are used in connection with the CCM algorithm. For instance, section 7.2.7.3 of IEEE Standard 802.15.3-2003 specifies the following use of an SFC:
“The Secure Frame Counter field shall be included in the frame body of all secure frames. The Secure Frame Counter field contains a 2-octet counter that is used to ensure the uniqueness of the nonce in a secure frame. A DEV shall not reuse a frame counter with the same time token as described in 7.3.1.1. and key as described in 9.3.5. The DEV shall initialize the SFC to zero for the first frame sent and increment it for each successive secure frame sent. When the time token, as described in 7.3.1, is updated, the DEV may reset the SFC to zero if desired or allow the counter to roll over. In the case where the DEV receives a new key, the DEV shall set the SFC to zero.”

As described above, IEEE 802.15.3 provides freshness protection features. Such features are described in section 9.1.7 of IEEE Standard 802.15.3-2003, which states:
“To prevent replay of old messages, a strictly-increasing time token is included in the beacon. A DEV may reject as invalid a received beacon with a time token less than or equal to the current time token. In addition, the time token is included in the CCM nonce, as described in 10.2.4, for each secure frame, as described in 7.2, so the integrity check will fail if a frame is replayed in a different superframe. A DEV in a secure piconet maintains two values for freshness. The CurrentTimeToken is the time token value found in the beacon for the current superframe and is used to protect all messages sent and check all messages received during that superframe. The LastValidTimeToken is used by the DEV to ensure that the security of the beacons have not been compromised.”

Thus, freshness protection in IEEE 802.15.3 is not complete as it allows frames to be replayed within a superframe. SFC numbers are not used for replay protection. Also, IEEE 802.15.3 requires re-encryption of data that is being resent. This may cause unnecessary processing burdens in the transmitting device. Such burdens are costly because they consume battery capacity and extra processing time.

In particular, this implementation is not very effective for OFDM-type burst communications, such as MBOA communications, in which data frames may be received in any order. For instance, when smaller than the latest SFC values are rejected, all resent data will have to be re-encrypted using new a SFC counter value. Also, the total number of available SFC's is limited to 48 bits for each session key, so unnecessary spending of SFC's may cause situations where new session keys have to be generated and exchanged among devices. This leads to unnecessary delays and power consumption. In turn, such delays lead to potential security risks.

The present invention advantageously provides replay protection without requiring transmitting devices to re-encrypt data frames designated for retransmission with new SFC values. Such frames may be designated for retransmission because they were unsuccessfully received. In embodiments of the present invention, receiving devices store information regarding received SFCs to monitor (or keep track of) SFC values that have been used in communication. Such features are described in greater detail below.

III. Device Implementation

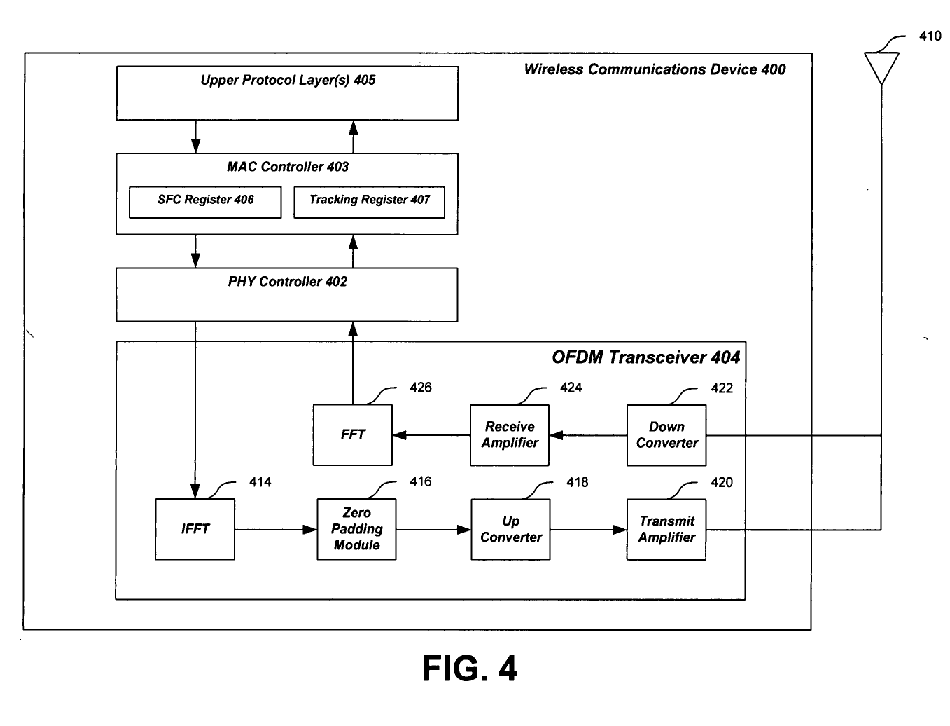

FIG. 4 is a diagram of a wireless communications device 400, which may operate according to the techniques of the present invention. This device may be used in various communications environments, such as the environment of FIG. 1. As shown in FIG. 4, device 400 includes a physical layer (PHY) controller 402, a media access controller (MAC) 403, an OFDM transceiver 404, upper protocol layer(s) 405, and an antenna 410.

MAC controller 403 generates frames for wireless transmission. In addition, MAC controller 403 receives and processes frames that are originated from remote devices. MAC controller 403 exchanges these frames with PHY controller 402. In turn, PHY controller 402 exchanges frames with OFDM transceiver 404. These frames may be in the format described above with reference to FIG. 4.

MAC controller 403 advantageously provides replay protection. In embodiments, this protection involves the storage of information. For instance, FIG. 4 shows that MAC controller 403 includes an SFC register 406 and a tracking register 407. Alternatively, these registers may be stored within device 400, but outside of MAC controller 403. These registers store information regarding received SFCs to provide for replay protection. In particular, SFC register 406 stores the largest received SFC value, and tracking register 407 monitors (or “tracks”) SFCs that have been previously employed. Details regarding the operation of these registers are provided below in greater detail.

FIG. 4 shows that OFDM transceiver 404 includes an inverse fast fourier transform (IFFT) module 414, a zero padding module 416, an upconverter 418, and a transmit amplifier 420. IFFT module 414 receives frames for transmission from PHY controller 402. For each of these frames, IFFT module 414 generates an OFDM modulated signal. This generation involves performing one or more inverse fast fourier transform operations. As a result, this OFDM modulated signal includes one or more OFDM symbols. This signal is sent to zero padding module 416, which appends one or more “zero samples” to the beginning of each OFDM symbol to produce a padded modulated signal. Upconverter 418 receives this padded signal and employs carrier-based techniques to place it into one or more frequency bands. These one or more frequency bands are determined according to a frequency hopping pattern, such as one or more of the TFCs. As a result, upconverter 418 produces a frequency hopping signal, which is amplified by transmit amplifier 420 and transmitted through antenna 410.

FIG. 4 shows that OFDM transceiver 404 further includes a downconverter 422, a receive amplifier 424, and a fast fourier transform (FFT) module 426. These components (also referred to as a receiver) are employed in the reception of wireless signals from remote devices. In particular, antenna 410 receives wireless signals from remote devices and sends them to downconverter 422. These wireless signals employ frequency hopping patterns, such as one or more of the TFCs.

Upon receipt, downconverter 422 employs carrier-based techniques to convert these signals from its one or more frequency hopping bands (e.g., TFC bands) into a predetermined lower frequency range. This results in modulated signals, which are received by amplifier 424 to generate amplified signals. FFT module 426 performs OFDM demodulation on these signals. This demodulation involves performing a fast fourier transform for each symbol that is conveyed in the amplified signals.

As a result of this demodulation, FFT module 426 produces one or more frames, which are sent to PHY controller 402. These frames may convey information, such as payload data and protocol header(s). Upon receipt, PHY controller 402 processes these frames. This may involve removing certain PHY layer header fields, and passing the remaining portions of the frames to MAC controller 403.

As shown in FIG. 4, device 400 further includes one or more upper protocol layers 405. These layers may involve, for example, user applications. Accordingly, upper layers 405 may exchange information with remote devices. This involves layer(s) 405 exchanging protocol data units with MAC controller 403. In turn, MAC controller 403 operates with PHY controller 402 and transceiver 404 to transmit and receive corresponding wireless signals.

The devices of FIG. 4 may be implemented in hardware, software, firmware, or any combination thereof. For instance, scanning module 406, upconverter 418, transmit amplifier 420, receive amplifier 424, and downconverter 422 may include electronics, such as amplifiers, mixers, and filters. Moreover, implementations of device 400 may include digital signal processor(s) (DSPs) to implement various modules, such as scanning module 406, IFFT module 414, zero padding module 416, and FFT module 426. Moreover, in embodiments of the present invention, processor(s), such as microprocessors, executing instructions (i.e., software) that are stored in memory (not shown) may be used to control the operation of various components in device 400. For instance, components, such as PHY controller 402 and MAC controller 403, may be primarily implemented through software operating on one or more processors.

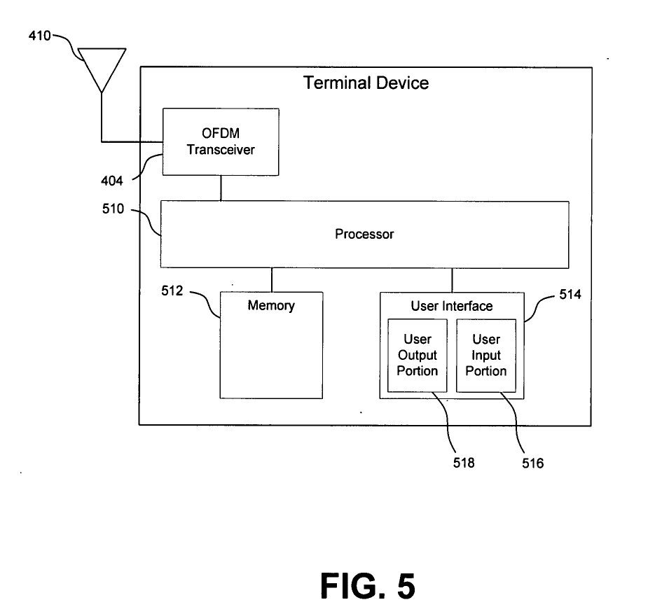

One such implementation of the FIG. 4 architecture is shown in FIG. 5. This diagram illustrates the terminal device implemented according to one embodiment of the present invention. As shown in FIG. 5, this implementation includes a processor 510, a memory 512, and a user interface 514. In addition, the implementation of FIG. 5 includes OFDM transceiver 404 and antenna 410. These components may be implemented as described above with reference to FIG. 4. However, the implementation of FIG. 5 may be modified to include different transceivers that support other wireless technologies.

Processor 510 controls device operation. As shown in FIG. 5, processor 510 is coupled to transceiver 404. Processor 510 may be implemented with one or more microprocessors that are each capable of executing software instructions stored in memory 512.

Memory 512 includes random access memory (RAM), read only memory (ROM), and/or flash memory, and stores information in the form of data and software components (also referred to herein as modules). These software components include instructions that can be executed by processor 510. Various types of software components may be stored in memory 512. For instance, memory 512 may store software components that control the operation of transceiver 404. Also, memory 512 may store software components that provide for the functionality of PHY controller 402, MAC controller 403, and upper protocol layer(s) 405.

In addition, memory 512 may store software components that control the exchange of information through user interface 514. As shown in FIG. 5, user interface 514 is also coupled to processor 510. User interface 514 facilitates the exchange of information with a user. FIG. 5 shows that user interface 514 includes a user input portion 516 and a user output portion 518.

User input portion 516 may include one or more devices that allow a user to input information. Examples of such devices include keypads, touch screens, and microphones. User output portion 518 allows a user to receive information from the device. Thus, user output portion 518 may include various devices, such as a display, and one or more audio speakers (e.g., stereo speakers) and a audio processor and/or amplifier to drive the speakers. Exemplary displays include color liquid crystal displays (LCDs), and color video displays.

The elements shown in FIG. 5 may be coupled according to various techniques. One such technique involves coupling transceiver 404, processor 510, memory 512, and user interface 514 through one or more bus interfaces. In addition, each of these components is coupled to a power source, such as a removable and/or rechargeable battery pack (not shown).

IV. Device Operation

As described above with reference to FIG. 4, devices may store information regarding the most recently received SFC and previously employed SFCs to provide replay protection. For instance, MAC controller 403 includes SFC register 406 and tracking register 407. Shown below is an example algorithm that employs these registers to determine whether a frame should be accepted or rejected. In this algorithm, the value stored by SFC register 406 is denoted as N. Accordingly, N denotes the largest received SFC value. Also, in this algorithm, tracking register 407 is a b-bit register denoted by s. The i^{th} bit of s is denoted below as sᵢ. This example involves register shifting operations. For instance, a shift left operation is denoted as s<<n, after which sᵢ contains the value stored at sᵢ₋ₙ. before the operation if i≧n. Otherwise, sᵢ is set to zero. The algorithm also makes use of an external function, checkIntegrity(F), telling whether the frame, F, including its SFC is authentic. This function may make this determination in various ways. One such way involves computing the nonce value corresponding to the SFC value and determining whether the nonce value is appropriate.

Upon receiving a frame F having the SFC, p, the algorithm performs the following:

```
if p > N−b then
    if p > N then
        if not checkIntegrity(F) then
            return REJECT
        endif
        s << (p − N)
        N [symbol] p
    endif
    if s_{N-p} = 0 and checkIntegrity(F) then
        s_{N-p} [symbol] 1
        return ACCEPT
    endif
endif
return REJECT
```

As shown above, this algorithm returns an ACCEPT (i.e., accepts frame F) when an authentic SFC value is greater than any previous SFC value; or when an authentic SFC value is within a window of size b, and has not been used before. Otherwise the algorithm returns a REJECT (i.e., rejects frame F). The authenticity of an SFC value may be verified after it has been checked that is in the correct range. Alternatively, this authenticity may first be verified.

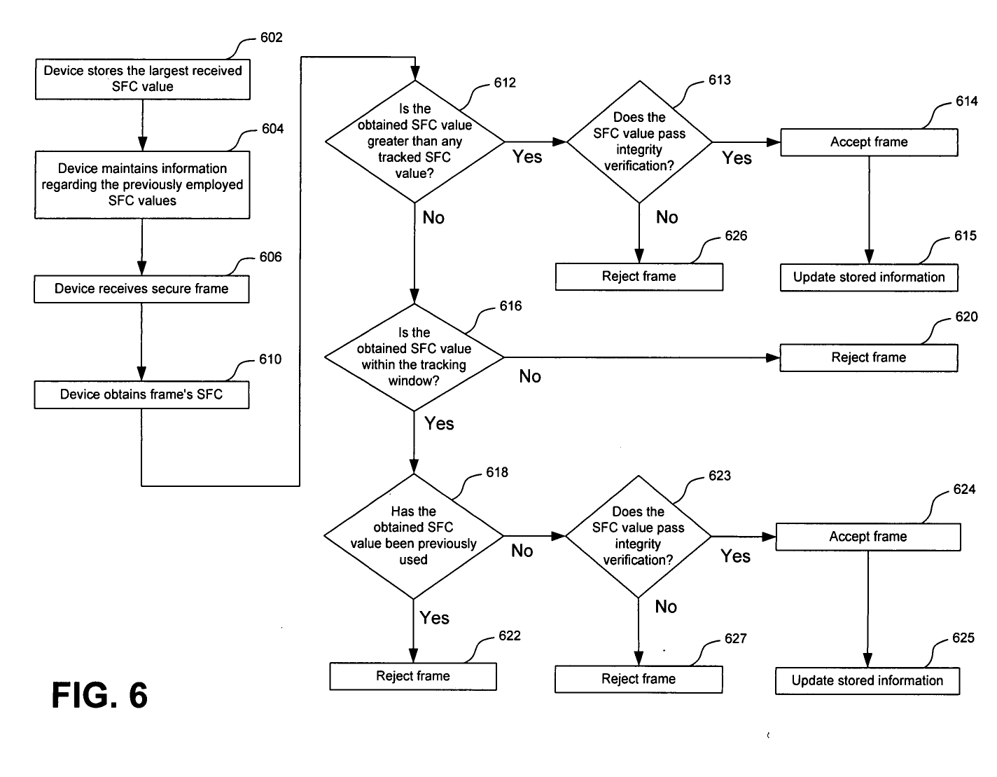

FIG. 6 is a flowchart illustrating an operation of a device, such as device 400, according to an embodiment of the present invention. This operation includes a step 601, in which the device participates in a short-range wireless network, such as a piconet of FIG. 1.

As shown in FIG. 6, the device stores various values. For instance, in a step 602, the device stores the lasrgest received SFC value. Also, the device maintains (or stores) information regarding the previously employed SFC values in a step 604. With reference to the device architecture of FIG. 4, these values may be stored in SFC register 406 and tracking register 407, respectively. However, the device may store this information in other ways. For instance, this information may be maintained in an SFC database.

The information stored in step 604 regarding the previously employed SFC values may have a tracking window associated with it. This tracking window specifies the extent to which previous values are tracked. For instance, the tracking window may extend to a predetermined number of SFC values within a range of the most recently received SFC value. In embodiments, this range only includes values that are less than the most recently received SFC value.

An example of such a range is provided by the above exemplary algorithm. In this algorithm, tracking register 407 is implemented as a b-bit register s. The value of each bit in this register indicates whether a particular SFC value (derivable from the most recently received SFC value in register 406 ) was previously received. Accordingly, in this implementation, the tracking window has a range b.

During the beginning of the device's participation in the network, initial values may be stored in steps 602 and 604. These initial values may be zero. However, in embodiments, other initial values may be employed.

In a step 606, the device receives a frame. This frame is secure. In a step 610, the device obtains the received frame's SFC. FIG. 6 shows that a step 612 follows step 610. In this step, the device determines whether the obtained SFC value is greater than any previous SFC value tracked by the device. For instance, in embodiments, this step may involve determining whether the SFC value obtained in step 610 is greater than the SFC value stored in step 602. If the obtained SFC value is greater than any previous SFC value tracked by the device, then operation proceeds to a step 613, in which the integrity of the SFC value is verified. Otherwise, operation proceeds to a step 616.

As shown in FIG. 6, the device determines the integrity and authenticity of the SFC value in step 613. This may be performed in various ways. One such way involves computing the nonce value corresponding to the SFC value and determining whether the nonce value is appropriate. If this step verifies the integrity and authenticity of the SFC value, the operation proceeds to a step 614, in which the frame received in step 606 is accepted. Otherwise the frame is rejected in a step 626.

In step 616, the device determines whether the SFC value obtained in step 610 is within the device's tracking window. If so, operation proceeds to a step 618, otherwise a step 620 is performed in which the frame is rejected.

In step 618, the device determines whether the obtained SFC value has been previously used. With reference to the above algorithm, this may involve checking the corresponding bit value in register s. For example, if the corresponding bit value is ‘1’, then the SFC value has been previously used. If the obtained SFC value has been previously used, then operation proceeds to a step 622 in which the frame is rejected. Otherwise, a step 623 is performed.

In step 623, the device determines the integrity and authenticity of the SFC value. This step may be performed in the same manner as step 613. If this step verifies the integrity and authenticity of the SFC value, then operation proceeds to a step 624, in which the frame received in step 606 is accepted. Otherwise the frame is rejected in a step 626.

Accordingly, the frame is accepted in steps 614 and 624. Upon this acceptance, the values stored in steps 602 and 604 may need to be updated. Thus, a step 615 follows step 614. In this step, the greatest SFC value received thus far (which was stored in step 602) is updated with the SFC value obtained in step 610. In addition, step 615 also includes updating information stored in step 604. This is because changing the value stored in step 602 also changes the device's tracking window. For example, with reference to the exemplary algorithm above, the register s is shifted to the left by the amount that the obtained SFC value exceeded the greatest SFC value received thus far. In addition, the values maintained in step 604 are updated. For example, the rightmost bit, s₀, of the register s is set equal to 1.

As shown in FIG. 6, a step 625 follows step 624. In this step, the device updates the information it maintains in step 604, since an SFC value within the devices tracking window has been received. For instance, with reference to the exemplary algorithm above, this step may include setting a bit in register s that corresponds to the obtained SFC value to ‘1’.

The operation of FIG. 6 may be performed repeatedly. In addition, further steps may be added to this operation. Moreover, other modifications may be made to this operation, as would be apparent to persons skilled in the relevant arts.

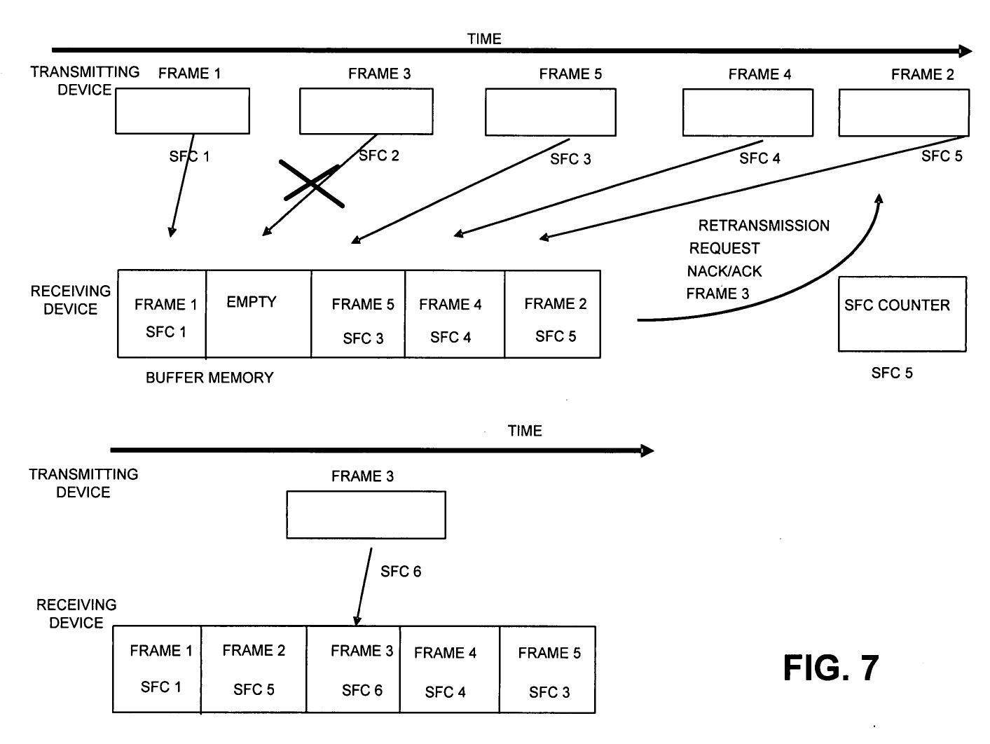

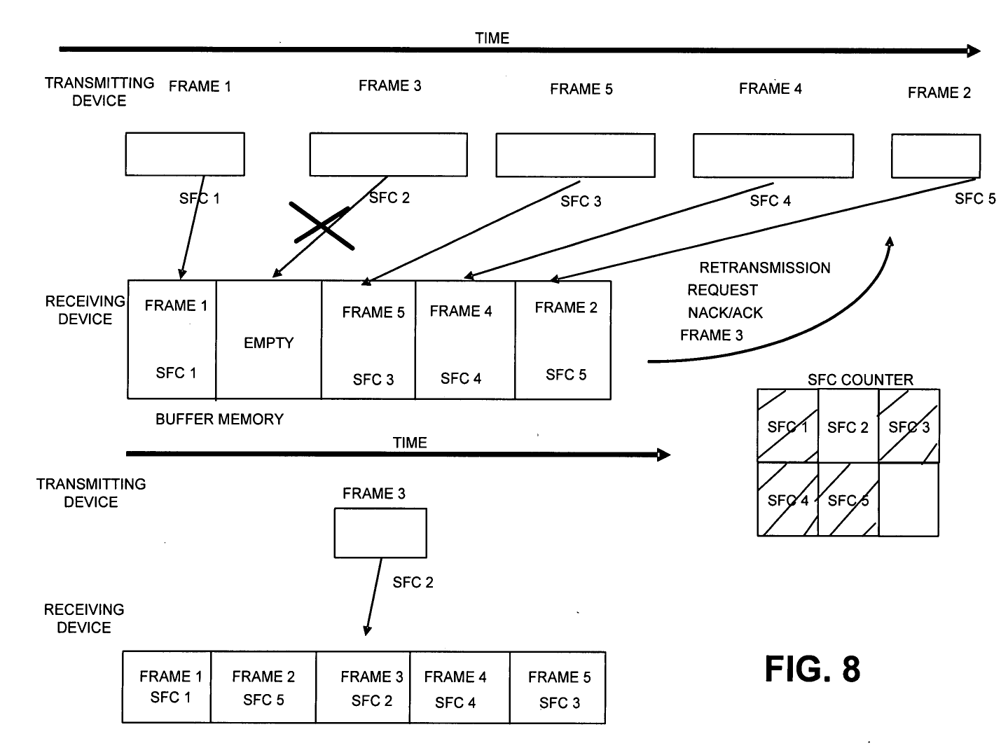

FIGS. 7 and 8 are diagrams illustrating interactions between two devices. In particular, these devices are a transmitting device (TD) and a receiving device (RD). These devices exchange secure frames across a network, such as a piconet of FIG. 1. These interactions are similar in that frames are transmitted, each of these frames including an SFC value. Moreover, in each of these interactions, an originally transmitted FRAME 3 (having SFC 2) is not received and the receiving device requests retransmission of this frame.

However, in FIG. 7, a conventional approach is employed where a new SFC value needs to be used for the retransmission. Thus, FRAME 3 is retransmitted with an SFC 6. In contrast, the interaction of FIG. 8 employs an approach of the present invention. As shown in FIG. 8, FRAME 3 is retransmitted with its original SFC 2. Therefore, the transmitting device does not need to undergo re-encryption and other costly processes to retransmit the frame. Thus, through enhanced processing and tracking of SFCs by the receiving device. Communications are streamlined.

V. Conclusion

While various embodiments of the present invention have been described above, it should be understood that they have been presented by way of example only, and not in limitation. For instance, although examples have been described involving IEEE 802.15.3 and/or IEEE 802.15.3a communications, other short-range and longer-range communications technologies are within the scope of the present invention. Moreover, the techniques of the present invention may be used with signal transmission techniques other than OFDM.

Accordingly, it will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. An apparatus, comprising:
a receiver configured to receive frames from a remote device across a wireless communications network, each of the frames having a secure frame counter (SFC);
a first register configured to store a highest received SFC value;
a second register, the second register configured to track previously used SFC values within a tracking window; and
a controller configured to accept or reject a newly received frame;
wherein the controller accepts the newly received frame upon the occurrence of one or more acceptance conditions, the one or more acceptance conditions including an SFC value of the newly received frame being greater than any previously received SFC value, or the SFC value of the newly received packet being within the tracking window and being previously unused.

2. The apparatus of claim 1, wherein the one or more acceptance conditions further includes the SFC value of the newly received frame being verified as authentic.

3. The apparatus of claim 1, wherein the second register is a binary register having a bit width, b, wherein each bit in the second register corresponds to an SFC value in the tracking range.

4. The apparatus of claim 1, wherein the wireless communications network is an IEEE 802.15.3 network.

5. The apparatus of claim 1, wherein the wireless communications network is an IEEE 802.15.3a network.

6. The apparatus of claim 1, wherein the receiver receives frames in the form of orthogonal frequency division multiplexing (OFDM) signals.

7. The apparatus of claim 1, wherein the controller updates the first and second registers when the newly received frame is accepted.

8. The apparatus of claim 1, wherein the controller rejects the newly received frame when the one or more acceptance conditions are not satisfied.

9. An apparatus, comprising:
a receiver configured to receive frames from a remote device across a wireless communications network, each of the frames having a secure frame counter (SFC);
a processor; and
a memory, the memory storing a first register for storing highest received SFC value, and a second register for tracking previously used SFC values within a tracking window;
wherein the memory further stores instructions for the processor to accept a newly received frame upon the occurrence of one or more acceptance conditions, the one or more acceptance conditions including an SFC value of the newly received frame being greater than any previously received SFC value, or the SFC value of the newly received frame being within the tracking window and being previously unused.

10. The apparatus of claim 9, wherein the one or more acceptance conditions further includes the SFC value of the newly received frame being verified as authentic.

11. The apparatus of claim 9, wherein the second register is a binary register having a bit width, b, wherein each bit in the second register corresponds to an SFC value in the tracking range.

12. The apparatus of claim 9, wherein the wireless communications network is an IEEE 802.15.3 network.

13. The apparatus of claim 9, wherein the wireless communications network is an IEEE 802.15.3a network.

14. The apparatus of claim 9, wherein the receiver receives frames in the form of orthogonal frequency division multiplexing (OFDM) signals.

15. The apparatus of claim 9, wherein the memory further stores instructions for the processor to update the first and second registers when the newly received frame is accepted.

16. The apparatus of claim 9, wherein the memory further stores instructions for the processor to reject the newly received frame when the one or more acceptance are not satisfied.

17. A method, comprising:
receiving a secure frame from a remote device across a wireless communications network;
obtaining a secure frame counter (SFC) value from the secure frame;
accepting the received frame upon the occurrence of one or more acceptance conditions, the one or more acceptance conditions including the obtained SFC value being greater than any previously received SFC value, or the obtained SFC value being within a tracking window and being previously unused.

18. The method of claim 17, wherein the one or more acceptance conditions further includes the SFC value of the newly received frame being verified as authentic.

19. The method of claim 17, further comprising decrypting the secure frame.

20. The method of claim 17, further comprising:
storing a highest value SFC of a received frame; and
tracking previously used SFC values within a tracking window.

21. The method of claim 20, wherein said tracking step comprises maintaining a register, the register configured to track previously used SFC values within a tracking window.

22. The method of claim 21, wherein the second register is a binary register having a bit width, b, wherein each bit in the second register corresponds to an SFC value in the tracking range.

23. The method of claim 20, wherein storing the highest SFC of a received frame comprises storing the obtained SFC when the received frame is accepted.

24. The apparatus of claim 17, wherein the wireless communications network is an IEEE 802.15.3 network.

25. The apparatus of claim 17, wherein the wireless communications network is an IEEE 802.15.3a network.

26. The method of claim 17, further comprising rejecting the received frame when the one or more acceptance conditions are not satisfied.

27. A computer program product comprising a computer useable medium having computer program logic recorded thereon for enabling a processor in a device to process a received frame, the computer program logic comprising:
program code for enabling the processor to receive a secure frame from a remote device across a wireless communications network;
program code for enabling the processor to obtain a secure frame counter (SFC) value from the secure frame; and
program code for enabling the processor to accept the received frame upon the occurrence of one or more acceptance conditions, the one or more acceptance conditions including the obtained SFC value being greater than any previously received SFC value, or the obtained SFC value being within a tracking window and being previously unused.
